(19) United States
(12) Patent Application Publication
(10) Pub. No.: US 2007/0213472 A1
(43) Pub. Date: Sep. 13, 2007

(54) Composition and method of use

(76) Inventors: Sung Dug Kim, Newburgh, IN (US); Ning Lu, White Plains, NY (US); Claire Qing Yu, Chicago, IL (US)

Correspondence Address: GEAM - O8CV - CPP;IP LEGAL, ONE PLASTICS AVENUE, PITTSFIELD, MA, 01201-3697, US

(21) Appl. No.: 11/371,794

(22) Filed: Mar. 9, 2006

(51) Int. Cl. C08G 63/91

(52) U.S. Cl. 525/446; 528/26; 528/29

(57) ABSTRACT

A composition comprising a polyester reacted with an epoxy silane, the product of said reaction having increased solvent resistance than the initial polyester.

### BACKGROUND OF THE INVENTION

Polyesters are well known in polymer chemistry for many decades. Among the properties for which polyesters are known are electrical, heat deflection temperature (HDT), flow rate, solvent resistance, and the like. When used in blends with the materials such as polycarbonates, impact modifiers and the like, it is usually the above-mentioned polyester properties which are sought after and improve such properties of the blend's other components.

We have now found that a polyester's [polybutylene terephthalate (PBT)] basic properties of solvent resistance, particularly to that of an organic, oil based solvent such as gasoline, can be significantly improved when the polyester is contacted with an epoxy silane, desirably where the epoxy is attached to a cycloaliphatic ring system.

### SUMMARY OF THE INVENTION

In accordance with the invention, there is a composition comprising a polyester reacted with an epoxy silane, the product of said reaction having better solvent resistance than the initial polyester.

### DETAILED DESCRIPTION OF THE INVENTION

The singular forms “a”, “an”, and “the” include plural referents unless the context clearly dictates otherwise.

“Optional” or “optionally” as used herein means that the subsequently described event may or may not occur, and that the description includes instances where the event occurs and the instances where it does not occur.

Any polyester can be the initial polyester provided it has carboxyl and/or alcohol end groups available for reaction with the epoxy silane. Examples of such polyester include PBT, polyethylene terephthalate (PET) any other aromatic diacid polyester with any other diol, or codiol or co-diaromatic acid. Examples of polyester include but are not limited to isophthalic acid containing polyesters, polyethylene naphthalate, iso and terephthalate containing polyesters, aliphatic diacid such as succinic, citric, malic, and the like containing polyesters, above or with other aliphatic diacids or together with an aromatic diacid containing polyesters. Various diols alone with polyester or comonomers such as trimethylene diol, pentane diol, cycloaliphatic diols such as 1,4-cyclohexane dimethanol (CHDM) alone with terephalic acid (PCT) or together with various quantities of butylene glycol or ethylene glycol such as PETG (more CHDM, less ethylene glycol (EG)), PETG (more EG, less CHDM) and combined with a cycloaliphatic diacid (cyclohexane diacarboxylic acid and 100% CHDM known as PCCD are all polyester within the definition. All of these polyesters have free carboxyl and/or alcohol groups, usually as end groups that can react with an epoxy silane.

The epoxy silane which is contacted with and reacts with the polyester is generally any kind of epoxy silane wherein the epoxy is at one end of the molecule and the silane is at the other end of the molecule. A desired epoxy silane within that general description is of the formula. 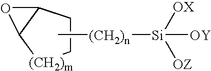
Wherein m is an integer 1, 2 or 3, n is an integer of 1 through 6 and X, Y, and Z are the same or different, preferably the same and are alkyl of one to twenty carbon atoms, inclusive, cycloalkyl of four to ten carbon atoms, inclusive, alkylene phenyl wherein alkylene is one to ten carbon atoms, inclusive, and phenylene alkyl wherein alkyl is one to six carbon atoms, inclusive.

Desirable epoxy silanes within the range are compounds wherein m is 2, n is 1 or 2, desirably 2, and X, Y, and Z are the same and are alkyl of 1, 2, or 3 carbon atoms inclusive. Epoxy silanes within the range which in particular can be used are those wherein m is 2, n is 2, and X, Y, and Z are the same and are methyl or ethyl.

The polyester modified with the epoxy silane can be blended with any of the usual additives and property modifier that polyesters are usually mixed for example glass, clay, mica and the like. Polymer blends can be made with reacted polyester or can be made with the unreacted polyester and the polyester then reacted with the epoxy silane. Examples of polymer which can be blended are aromatic polycarbonates, polysulfones, polyethesulfones, and impact modifiers.

The polyester can be mixed with blend components and then reacted with the epoxy silane. However, the epoxy silane is theoretically combinable with other components of the blend which might bring about undesirable as well as desirable properties.

The epoxy silane is reacted with the polyester by simply bringing the two components together at a temperature and time period. For example, PBT 195, Intrinsic Viscosity (IV) 1.1 from GE together with PBT 315, IV 0.7 from GE are combined with various additives such as potassium diphenylsulfone sulfonate (KSS), a flame retardant, a hindered phenol such as Irganox 1010 from Ciba Geigy, a catalyst such as sodium stearate, a mold release such as pentaerythritol tetrastearate (PETS) and the epoxy silane beta-(3,4-epoxycyclohexyl)ethyl triethoxysilane Coatosil 1770 from GE in an extruder where they are tumble blended and then extruded in a 27 mm twin screw with a vacuum vented mixing screw at a barrel and die head temperature between 240 and 265 degrees Celsius and 450 ppm screw speed. The extrudate is cooled through a water bath prior to palletizing.

The quantity of epoxy silane employed as a percentage of polyester present in the composition is generally about 0.2 to about 2.0 wt % and within that range a minimum of about 0.5 wt %. Generally, further increases in desirable properties are not observable beyond a maximum of about 1.75 wt %.

Various processes can be used to bring about a desired final product. Injection molding, blow molding, thermoforming, films, poltrusion and the like are processes which can be employed. Where solvent resistance is particularly desirable products and parts exposed to gasoline vehicular parts like gas caps, fenders, gasoline tanks, and the like can be successfully prepared using the above processes. Any other desired article can also be prepared using certain of the processes.

Below are examples of the invention where examples show increased resistance to organic solvent(s) over time using tensile strength as test system.

Materials:

Table 1 summarizes the material used in the experiments.

TABLE 1
Materials

| Abbreviation | Description |
|---|---|
| PBT 195 | Poly(1,4-butylene terephthalate), IV 1.1 from GE |
| PBT 315 | Poly(1,4-butylene terephthalate) IV 0.7 from GE |
| Coatosil | beta-(3,4-epoxycyclohexyl)ethyl triethoxysilane from GE |
| 1770 | Silicone |
| | 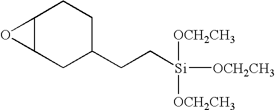 |
| KSS | potassium diphenylsulfone sulfonate (KSS) |
| AO1010 | Hindered Phenol, Pentaerythritol tetrakis(3,5-di-tert-butyl- |
| | 4-hydroxyhydrocinnamate) sold as IRGANOX 1010 from |
| | Ciba Geigy |
| NaSt | Sodium Stearate, catalyst |
| PETS | pentaerythritol tetrastearate, mold release |

Extrusion and Molding Conditions:

The ingredients were tumble blended and then extruded on 27 mm twin screw extruder with a vacuum vented mixing screw, at a barrel and die head temperature between 240 and 265 degrees C. and 450 ppm screw speed. The extrudate was cooled through a water bath prior to pelletizing. Test parts were injection molded on a van Dom molding machine with a set temperature of approximately 250° C. The pellets were typically dried for 3-4 hours at 120° C. in a forced air-circulating oven prior to injection molding.

Testing:

Mechanical properties

Tensile properties were tested on Type I tensile bars at room temperature with a crosshead speed of 2 in./min. according to ASTM D648. Notched Izod testing was done on 3-×½×⅛ inch bars according to ASTM D256. The flexural bars were tested for flexural properties as per ASTM 790.

Tensile bars were immersed in gasoline or Fuel C at room temperature or 82° C.

Results and Discussion:

TABLE 2
Gasoline Resistance at room temperature.

| | | Formulation | | | | | | | |
|---|---|---|---|---|---|---|---|---|---|
| | | C1 | C2 | C3 | C4 | C5 | E1 | E1 | E3 |
| PBT 315 | % | | 100 | 49.95 | 49.9 | 49.65 | 48.95 | 48.9 | 48.65 |
| PBT 195 | % | 100 | | 50 | 50 | 50 | 50 | 50 | 50 |
| Irganox 1010 | % | | | 0.05 | 0.05 | 0.05 | 0.05 | 0.05 | 0.05 |
| Coatosil 1770 | % | | | 0 | 0 | 0 | 1 | 1 | 1 |
| Na Stearate | % | | | 0 | 0.05 | 0 | 0 | 0.05 | 0 |
| KSS | % | | | 0 | 0 | 0.3 | 0 | 0 | 0.3 |
| Physical Properties | | | | | | | | | |
| MVR-pellets* | cc/10 min | 100 | 10 | 38 | 40 | 39 | 10 | 0 | 13 |
| MV at 250° C. and | Pa-s | 67 | 1047 | 301 | — | — | 933 | 4721 | 732 |
| 24/s** | | | | | | | | | |
| MV at 250° C. and | Pa-s | 65 | 344 | 159 | — | — | 238 | 527 | 204 |
| 1520/s | | | | | | | | | |
| MV at 250° C. and | Pa-s | — | 213 | 115 | — | — | 152 | 337 | 138 |
| 3454/s | | | | | | | | | |
| Tensile Stress @yield | Mpa | 61 | 59 | 59 | 60 | 60 | 58 | 65 | 58 |
| Tensile Stress @break | Mpa | 59 | 30 | 39 | 45 | 48 | 27 | 49 | 33 |
| Tensile Elogation at | % | 15 | 280 | 32 | 29 | 44 | 202 | 30 | 84 |
| break | | | | | | | | | |
| GPC-Mn | kg/mol | 18 | 42 | 27.7 | 27.7 | 28.5 | 28.8 | 30 | 29.2 |
| GPC-Mw | kg/mol | 45 | 105 | 85.4 | 84.2 | 85.7 | 88.9 | 97.3 | 89.3 |
| Mw/Mn | | 2.5 | 2.5 | 3.1 | 3 | 3.1 | 3.1 | 3.2 | 3.1 |
| Gasoline Resistance⁺ | | | | | | | | | |
| TS⁺⁺ Retention after | % | 83% | 87% | 98% | 96% | 91% | 99% | 99% | 97% |
| 1 day | | | | | | | | | |
| TS Retention after 2 day | % | 78% | 86% | 91% | 90% | 87% | 99% | 98% | 96% |
| TS Retention after 4 day | % | 81% | 92% | 93% | 91% | 92% | 99% | 99% | 98% |
| TS Retention after 8 day | % | 77% | 82% | 89% | 88% | 87% | 96% | 99% | 98% |

*MVR (melt volume rate) was measured at 250° C. with a load of 2.16 kg after 4 minutes dwell time
**MV (Melt Viscosity) was measured by capillary viscometer at various shear rate
⁺ASTM Tensile Type I bars were immersed in regular gasoline from BP co. with 2.5% strain.
⁺⁺Tensile Stress at Yield

Table 2 shows the effect of the epoxy silane on physical properties and chemical resistance to gasoline. Formulations of C3-C5 & E1-E3 were designed to investigate the effect of epoxy silane and additives on PBT. Tensile bars were tested under 2.5% strain in gasoline at room temperature. Examples of E1-E3 with epoxy silane show substantially higher retention in tensile strength after gasoline exposure than comparative examples C1-C5.

TABLE 3
The interaction between PBT type and epoxy silane.

| | | Formulation | | | |
|---|---|---|---|---|---|
| | | C6 | E4 | C7 | E5 |
| PBT 315 | % | 100.0 | 98.5 | | |
| PBT 195 | % | | | 100.0 | 98.5 |
| Coatosil 1770 | % | | 1.5 | | 1.5 |
| NaSt | % | | 0.01 | | 0.01 |
| KSS | % | | | | |
| Gasoline Resistance* | | | | | |
| TS Retention after 4 day** | % | 92% | 98% | 81% | 87% |

*ASTM Tensile Type I bars were immersed in regular gasoline from BP co. with 2.5% strain.
**Tensile Stress at Yield

Table 3 shows that the epoxy silane improves gasoline resistance of PBT195 and PBT315.

TABLE 4
Gasoline resistance at 82° C.

Formulation

| | | C8 | C9 | E6 | E7 | E8 |
|---|---|---|---|---|---|---|
| PBT 315 | % | | 100 | 48.7 | 48.7 | 48.4 |
| PBT 195 | % | 100 | | 50 | 50 | 50 |
| Irganox 1010 | % | | | 0.05 | 0.05 | 0.05 |
| Coatosil 1770 | % | | | 1 | 1 | 1 |
| Na Stearate | % | | | 0 | 0.05 | 0 |
| KSS | % | | | 0 | 0 | 0.3 |
| Carbon Black | % | | | 0.25 | 0.25 | 0.25 |
| Gasoline Resistance | | | | | | |
| TS before exposure* | Mpa | 55 | 54 | 59 | 59 | 59 |
| TS Retention after 7 days, | % | 83% | 87% | 94% | 96% | 94% |
| Tensile bars under no strain | | | | | | |
| TS Retention after 7 days, | % | 80% | 85% | 94% | 91% | 94% |
| Tensile bars under 1.0% strain | | | | | | |

*Tensile Stress at Yield

Table 4 shows the effect of the epoxy silane on physical properties and chemical resistance to gasoline at elevated temperature. Tensile bars were tested under 0% or 1.0% strain in gasoline at 82° C. Examples of E6-E8 with epoxy silane show substantially higher retention in tensile strength after gasoline exposure at 82° C. than comparative examples C8-C9.

TABLE 5
Chemical resistance to Fuel C at room temperature.

| | | Formulation | | | | |
|---|---|---|---|---|---|---|
| | | C10 | C11 | E9 | E10 | E11 |
| PBT 315 | % | | 100 | 48.7 | 48.7 | 48.4 |
| PBT 195 | % | 100 | | 50 | 50 | 50 |
| Irganox 1010 | % | | | 0.05 | 0.05 | 0.05 |
| Coatosil 1770 | % | | | 1 | 1 | 1 |
| Na Stearate | % | | | 0 | 0.05 | 0 |
| KSS | % | | | 0 | 0 | 0.3 |
| Carbon Black | % | | | 0.25 | 0.25 | 0.25 |
| Resistance to Fuel C* | | | | | | |
| TS before exposure*** | Mpa | 60 | 60 | 58 | 57 | 59 |
| TS Retention after 4 days, | % | 86% | 87% | 95% | 98% | 95% |
| Tensile bars under 2.5% strain | | | | | | |
| TS Retention after 8 days, | % | 14% | 85% | 94% | 96% | 95% |
| Tensile bars under 2.5% strain | | | | | | |

*Fuel: mixture of 15% Methanol, 42.5% Toluene, 42.5% Isooctane
**ASTM Tensile Type I bars were immersed at room temperature
***Tensile Stress at Yield

Table 5 shows the effect of the epoxy silane on physical properties and chemical resistance to Fuel C. Tensile bars were tested under 2.5% strain in Fuel C at room temperature. Examples of E9-E11 with epoxy silane show substantially higher resistance to Fuel C than comparative examples C10-C11.

1. A composition comprising a polyester reacted with an epoxy silane, the product of said reaction having increased solvent resistance than the initial polyester.

2. The composition in accordance with claim 1 wherein the polyester is polybutylene terephthalate.

3. The composition in accordance with claim 1 wherein the composition has additional polymer components therein.

4. The composition in accordance with claim 2 wherein the composition has additional polymer components therein.

5. A method for increasing the solvent resistance of a polyester which comprises reacting the polyester with an epoxy silane.

6. The method in accordance with claim 5 wherein the epoxy silane is about 0.1 to about 2.0 wt % of the polyester.

7. The method in accordance with claim 5 wherein the polyester is polybutylene terephthalate.

8. The method in accordance with claim 6 wherein the polyester is polybutylene terephthalate.

9. The method in accordance with claim 5 wherein the epoxy silane has an epoxy cycloaliphatic group at one end and a silane at the other end.

10. The method in accordance with claim 6 wherein the epoxy silane has an epoxy cycloaliphatic group at one end and a silane at the other end.

11. The method in accordance with claim 7 wherein the epoxy silane has an epoxy cycloaliphatic group at one end and a silane at the other end.

12. The method in accordance with claim 5 wherein the epoxy silane is beta-(3,4-epoxycyclohexyl) ethyl triethoxysilane.

13. The method in accordance with claim 5 wherein the epoxy silane is beta-(3,4-epoxycyclohexyl) ethyl triethoxysilane.

14. The method in accordance with claim 8 wherein the epoxy silane is beta-(3,4-epoxycyclohexyl) ethyl triethoxysilane.
